(19) United States
(12) Patent Application Publication
(10) Pub. No.: US 2007/0118502 A1
(43) Pub. Date: May 24, 2007

(54) Methods and systems for managing a fleet of assets

(76) Inventors: James Kenneth Aragones, Clifton Park, NY (US); Amy Aragones, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/283,179

(22) Filed: Nov. 18, 2005

(51) Int. Cl. G06F 17/30

(52) U.S. Cl. 707/2

(57) ABSTRACT

Methods and systems for a mission planning system for a fleet of assets are provided. The system includes a centralized database for storing information, a computer system configured to be coupled to the database wherein the computer system includes a mission model configured to analyze a plurality of missions to be executed by the fleet of assets, the missions being defined by at least one task sequence and a set of environmental parameters associated with each task sequence, an asset model configured to determine the capability of each asset to perform the task sequence associated with at least one mission using the historical data, the threshold data, and the mission analysis, and a selection model configured to match at least one asset to each mission based on the determined asset capability, such that the capability of all assets is facilitated being optimized.

### STATEMENT REGARDING FEDERALLY SPONSORED RESEARCH OR DEVELOPMENT

The U.S. Government may have certain rights in this invention pursuant to contract number F33615-03-2-6300.

### BACKGROUND OF THE INVENTION

This application relates generally to managing assets and, more particularly, to methods and systems for optimizing lifetime costs of a fleet of assets.

The total cost of ownership of a fleet includes purchase, operating, and service costs. Given that purchase price is fixed, daily decisions can be made which affect the operating and service costs of assets. One such decision is the assignment of missions (routes) to each asset to alter the fuel consumption profile, the repair capacity required, and asset maintenance costs.

On-condition maintenance of equipment results in process variability that requires excess capability to insure availability. Whether such excess capability is in the form of assets or repair capacity, additional maintenance costs are incurred. One solution is to simply remove engines early, sacrificing life to reduce variability. However, modifying the mission (route) to facilitate reducing variability does not sacrifice the operational life left in the asset.

Assets, such as turbine engines, are subject to failure by two types of causes. Wear, which is highly correlated to operating hours (engine flight hours), and thermal shock, which is highly correlated to start events (engine cycles). A determination to assess the mode more probable to cause failure of the asset can be made and the mission (hours per cycle or flight leg for an aircraft engine) can be selected to balance the failure modes, increasing the utilization of the life built into the engine. The ability to make this selection is facilitated when there are multiple assets that can be selected for different missions to optimize operational life for the fleet.

Individual assets, such as turbine engines can differ in their fuel efficiency due to configuration, age, and environment. Aircraft routes (missions) differ in fuel requirements based on for example, but not limited to, load (passengers and cargo), altitude, temperature, and humidity. Fuel consumption varies for each engine on each route. An optimal assignment of missions for each aircraft may be made to minimize total daily fuel cost for the fleet.

However, because of labor and cost constraints such matching techniques may be impracticable in some instances.

### BRIEF DESCRIPTION OF THE INVENTION

In one embodiment, a mission planning system for a fleet of assets includes a centralized database for storing information, a computer system configured to be coupled to the database wherein the computer system includes a mission model configured to analyze a plurality of missions to be executed by the fleet of assets, the missions being defined by at least one task sequence and a set of environmental parameters associated with each task sequence, an asset model configured to determine the capability of each asset to perform the task sequence associated with at least one mission using the historical data, the threshold data, and the mission analysis, and a selection model configured to match at least one asset to each mission based on the determined asset capability, such that the capability of all assets is facilitated being optimized.

In another embodiment, a method of managing life cycle costs associated with maintaining and operating a fleet of assets includes storing historical data relating to missions executed by each asset in a database wherein the historical data includes asset performance data and environmental data for each mission. The method also includes storing threshold data for each asset in the database wherein the threshold data relates to endurance limits for each asset. A plurality of missions to be executed is analyzed wherein the missions are defined by at least one task sequence and a set of environmental parameters associated with each task sequence. The method includes determining the capability of each asset to perform the task sequence associated with at least one mission using the historical data, the threshold data, and the mission analysis, and matching at least one asset to each mission based on the determined asset capability, such that the capability of all assets is facilitated being optimized, the matching is performed using a computer.

In yet another embodiment, a computer program for managing life cycle costs associated with maintaining and operating a fleet of assets is provided. The program is embodied on a computer readable medium and includes at least one code segment that stores historical data relating to missions executed by each asset in a database wherein the historical data includes asset performance data and environmental data for each mission, stores threshold data for each asset in the database wherein the threshold data relates to endurance limits for each asset, analyzes a plurality of missions to be executed wherein the missions are defined by at least one task sequence and a set of environmental parameters associated with each task sequence. The at least one code segment also determines the capability of each asset to perform the task sequence associated with at least one mission using the historical data, the threshold data, and the mission analysis, and matches at least one asset to each mission based on the determined asset capability, such that the capability of all assets is facilitated being optimized.

### BRIEF DESCRIPTION OF THE DRAWINGS

FIG. 1 is a schematic diagram of a general-purpose computer system in which a system for fleet mission planning operates;

FIG. 2 is a schematic diagram of an exemplary mission chart that may be used in a fleet mission planning system;

FIG. 3 is a schematic data flow diagram of an exemplary fleet asset management system that may be used with the fleet mission planning computer system shown in FIG. 1;

FIG. 4 is a flow chart of an exemplary method of managing life cycle costs associated with maintaining and operating a fleet of assets; and

FIG. 5 is a data flow diagram of an exemplary embodiment of the fleet mission planning system shown in FIG. 2.

### DETAILED DESCRIPTION OF THE INVENTION

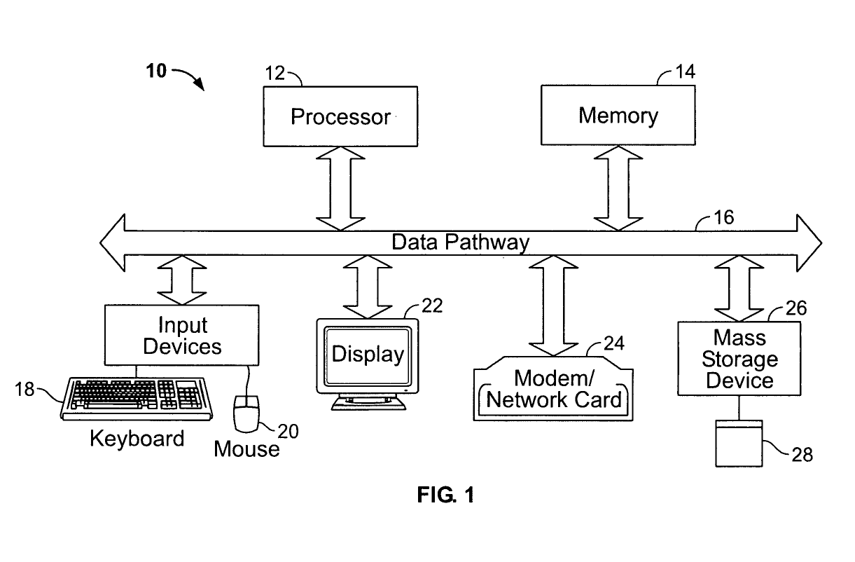

FIG. 1 is a schematic diagram of a general-purpose computer system 10 in which a system for fleet mission planning operates. The computer system 10 generally comprises a processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. Memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices comprise a keyboard 18 and a mouse 20 that enter data and instructions into the computer system 10. A display 22 allows a user to see what the computer has accomplished. Other output devices could include a printer, plotter, synthesizer and speakers. A modem or network card 24 enables the computer system 10 to access other computers and resources on a network. A mass storage device 26 allows the computer system 10 to permanently retain large amounts of data. Mass storage device 26 may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, personal computer, workstation, mini-computer, mainframe computer, and supercomputer. In the exemplary embodiment, a database 28 for storing information is embodied on mass storage device 26. At certain times during operation of system 10, database 28 is embodied in memory 14.

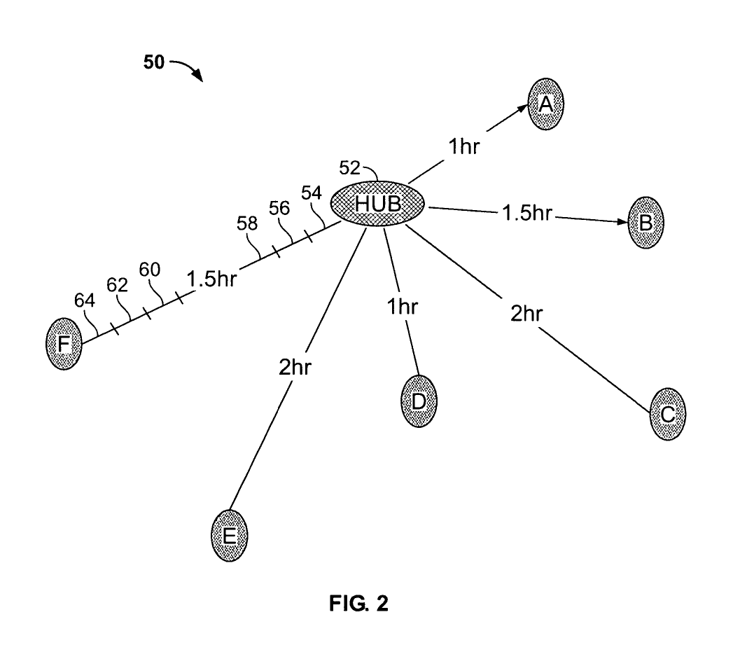

FIG. 2 is a schematic diagram of an exemplary mission chart 50 that may be used in a fleet mission planning system. In the exemplary embodiment, mission chart 50 includes a hub or origination point 52 of a plurality of missions. In an alternative embodiment, mission chart 50 includes a plurality of origination points 52. Each origination point 52 includes a plurality of associated destination points, such as destination points A-F. In various alternative embodiments, origination point 52 may include any number of associated destination points. Each destination point includes an associated duration associated with a traversal from origination point 52 to a respective destination point. As illustrated in FIG. 2 the durations may be expressed in units of hours, such as operating hours of an asset traversing a route from origination point 52 to a respective destination point. The durations may also be expressed in other units, such as distance. Each traversal between origination point 52 and a destination point is a mission. Each mission includes one or more tasks. In an embodiment wherein the asset comprises an aircraft, the mission may include a takeoff task 54, a climbout task 56, a cruise task 58, a descent task 60, an approach task 62, and a landing task 64. Each task is performed in an environment that is unique to that task and the environment may affect the performance of the asset performing that task, and each asset may also perform differently from other assets performing the same task. Accordingly, matching certain assets to missions may yield a different level of performance and cost for the fleet of assets than the assets matched to different missions.

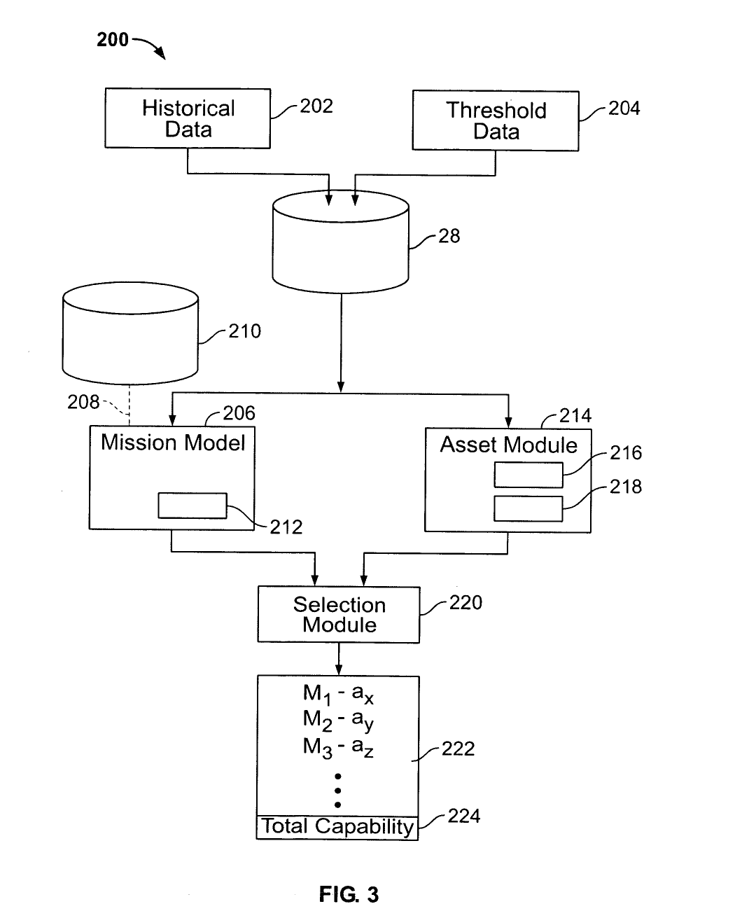

FIG. 3 is a schematic data flow diagram of an exemplary fleet mission planning system 200 that may be used with the general purpose computer system 10 (shown in FIG. 1). Fleet mission planning system 200 includes database 28 that is configured to receive and store historical data 202 from the fleet of assets. Database 28 is also configured to receive and store threshold data 204 wherein at least some of threshold data 204 relates to historical data 202. Threshold data 204 may be, but not limited to, operational limits, performance parameters that trigger maintenance actions, or inspection tolerances that are used to determine wear and remaining life of an asset. Threshold data 204 may be received from original equipment manufacturer's (OEM) literature, including for example, notices, bulletins, technical and operational manuals, regulatory notices, or may be developed in-house or by third party engineers based on preferred operational strategies.

In the exemplary embodiment, database 28 is comprised in a single database located in a single location. In an alternative embodiment, database 28 is comprised of various databases located on several computers or servers, and may be located remotely with respect to each other and may be communicatively coupled through a network.

A mission model 206 is configured to receive historical data 202 and threshold data 204 from database 28 to determine the set of missions to be executed and the environment and requirements of each mission. In an alternative embodiment, mission model 206 receives mission data 208 from a database 210 that is maintained separately from database 28. Database 210 may be developed, owned, and maintained by a different business entity than database 28. Mission model 206 may receive mission data 208 only from database 210 and may not receive any data from database 28. In the exemplary embodiment, mission model 206 includes a route model 212 configured to determine task sequences to be executed wherein the task sequences include a travel leg length, an asset loading wherein the asset loading includes at least one of passengers, cargo, and fuel, and profiles of an altitude, an ambient temperature, a wind speed, a current speed, an ambient humidity along the travel leg. In an embodiment of the invention the profiles include at least one of an average profile value for the travel leg, a transfer function relating travel conditions to profile values, and a transfer function relating travel conditions to profile values that includes a profile value uncertainty distribution.

An asset model 214 describes the capabilities of each asset with respect to the environment specified by mission model 206. In the exemplary embodiment, asset model 214 is configured to determine the capability of each asset to perform the task sequence associated with at least one mission using the historical data, the threshold data, and the mission analysis. In various embodiments, asset model 214 includes a fuel consumption model 216 configured to determine a current and projected fuel consumption profile for each asset. In various other embodiments, asset model 214 includes a life estimation model 218 configured to estimate the life of the asset. Life estimation model 218 determines life remaining in the asset given the historical data received corresponding to the asset. Life estimation model 218 is also used to determine initial lifespan of new assets that have no historical data recorded.

A route selector 220 is configured to match at least one asset to a mission such that at least one of the total fleet fuel consumption is facilitated being minimized, an average time to failure is facilitated being maximized, and an average time to required maintenance is facilitated being maximized. Route selector 220 includes at least one of an exhaustive algorithm, a non-exhaustive search method, and an evolutionary algorithm wherein the exhaustive algorithm selects each combination of asset and mission possible to evaluate effects of each pairing. The evolutionary algorithm learns from past evaluations to anticipate which of the historical data affects the outcome of the pairings to the greatest extent. Other evolutionary algorithms use other methods to use past evaluations to improve the determination of pairings of assets and missions that facilitate optimizing the total costs to the fleet of assets.

A forecast module 222 estimates the effects of a mission-asset matching. A set of mission-asset matches is used for trade-off or what-if analysis. The analyzed mission-asset match 224 that facilitates optimizing the costs of the fleet of assets can then be selected from the set of mission-asset matches.

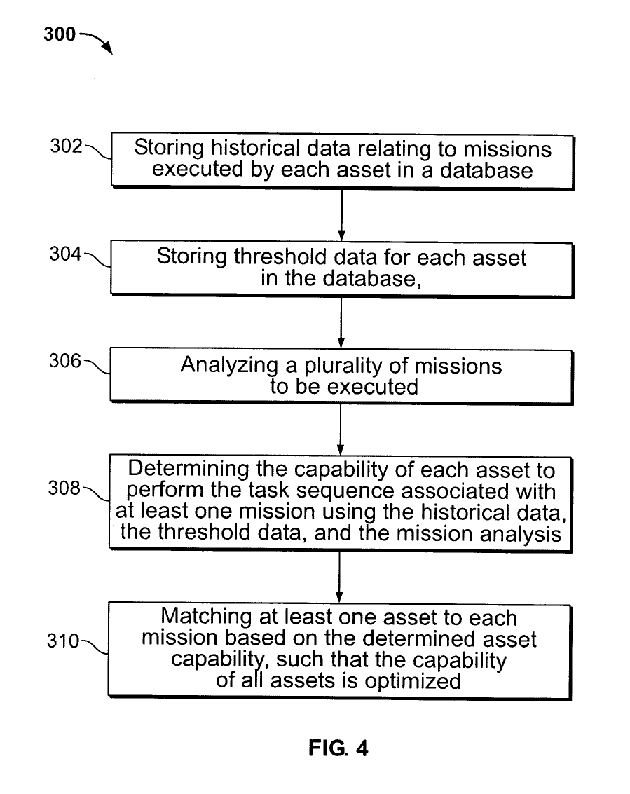

FIG. 4 is a flow chart of an exemplary method 300 of managing life cycle costs associated with maintaining and operating a fleet of assets. Method 300 includes storing 302 historical data relating to missions executed by each asset in a database, such as database 28 embodied on mass storage device 26. At certain times database 28 may be embodied in memory 14. The historical data generally includes asset performance data and environmental data for each mission. The asset may be any vehicle especially a vehicle used in a fleet of vehicles that are substantially interchangeable with each other to perform a series of tasks that make up a mission. For example, the assets are a fleet of delivery trucks, taxi cabs, ships, aircraft, or trains. The performance data relates to parameters that can be used to determine a maintenance or operational state of the asset, or to parameters that can be used to predict the performance of an asset in certain environmental conditions, such as an altitude, an ambient temperature, a wind speed and direction, an ambient humidity level, and a load wherein the load includes at least one of fuel, passengers, and cargo. Asset fuel efficiency is also used to track the performance of an asset and fuel use parameters relative to each task of a task sequence are also stored in the historical data. Data associated with a predetermined failure mechanism of the asset and asset operating hours and asset start events are also stored in database 28.

The method also includes storing 304 threshold data for each asset in the database wherein the threshold data relates to endurance limits for each asset. For example, manufacturers or regulatory bodies have requirements that dictate maintenance or inspections actions are to be performed within predetermined hours of operation of the asset, or other milestones. Requirements may also dictate maintenance or inspection actions when a measurable parameter associated with the asset attains a predetermined level, for example, a pressure exceeded a pressure limit, or a vibration level exceeding a predetermined threshold. The parameters may also be trends of measured or inferred values.

A plurality of missions to be executed is analyzed 306 wherein the missions are defined by at least one task sequence and a set of environmental parameters associated with each task sequence. For example, a mission may be an airline flight from an origin A to a destination B. Tasks that are performed during the airline flight typically are defined as takeoff, cruise, and landing. Each task may have different environmental considerations and requirements. An elevation, ambient temperature, air salinity, and ambient humidity at an airport at origin A may limit the aircraft, aircraft loading, or aircraft performance capability during takeoff. Weather, air currents aloft, a temperature may affect aircraft performance during cruise. Environmental and other missions related parameters may affect the aircraft ability to land at destination B.

The capability of each asset to perform the task sequence associated with at least one mission is determined 308 using the historical data, the threshold data, and the mission analysis. For example, individual gas turbine engines can differ in their fuel efficiency due to configuration, age, and environment. Aircraft routes or missions differ in fuel requirements based on load (passengers, cargo, and fuel carried), altitude, temperature, and humidity. A projected fuel consumption profile for each asset is determined for use in determined an asset capability to perform during a mission. Fuel consumption varies for each engine on each mission. An optimal assignment of missions for each aircraft to minimize total daily fuel cost for the fleet is determined by matching 310 at least one asset to each mission based on the determined asset capability, such that the capability of all assets is facilitated being optimized and/or the total fuel consumption of the fleet of assets is facilitated being minimized. Additionally, the historical asset operating hours data and asset start events data are compared to associated asset operating hours threshold data and asset start event data to determine is the asset is nearing a mandated maintenance or inspection action. For example, an asset with a relatively large differential between historical operating hours and threshold operating hours is generally matched 310 to a mission that includes a relatively large operating hour requirement and an asset with a relatively large differential between historical asset start events and threshold asset start events is generally matched 310 to a mission that includes a relatively large asset start events requirement. Such matching 310 may be overridden by parameters and thresholds that have greater importance for safety reasons or may be overridden due to impacts to the whole fleet that make the entire fleet more optimally matched.

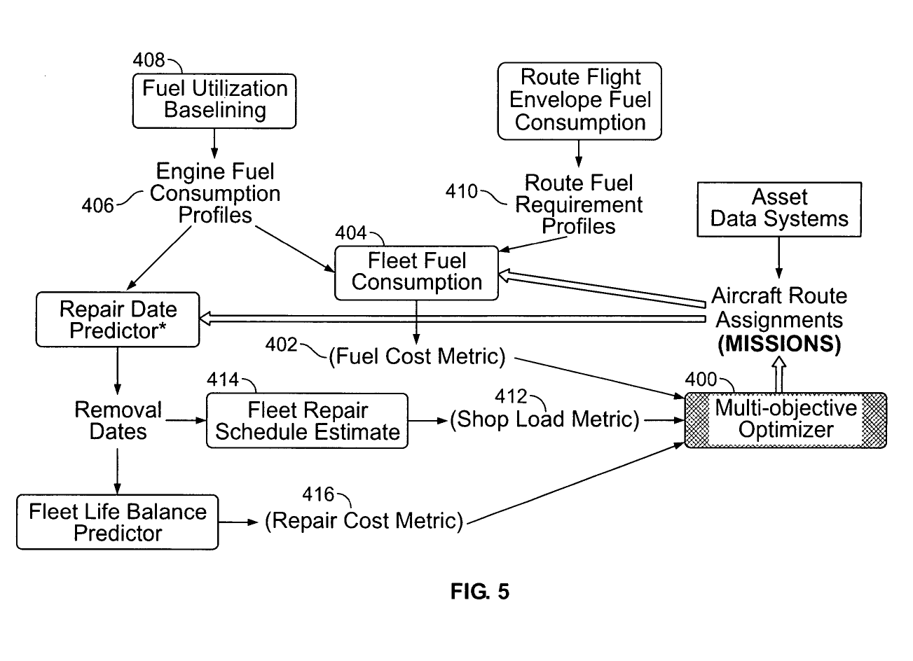

FIG. 5 is a data flow diagram 400 of an exemplary embodiment of the fleet mission planning system 200 (shown in FIG. 2). In the exemplary embodiment, fleet mission planning system 200 includes a multi-objective optimizer 400 that receives metrics determined from a plurality performance, maintenance, operations, and business constraints. Multi-objective optimizer 400 determines a matching of assets to missions that facilitates optimizing the costs of operating and maintaining the fleet of assets being managed. For example, a particular capability of an asset may not be optimized for a particular asset by multi-objective optimizer 400 because multi-objective optimizer 400 tends to optimize the capabilities of the whole fleet of assets. Accordingly, tradeoffs may be made to select a matching of assets to missions that is not the optimal match for a particular asset but, facilitates optimally matching of the fleet assets to the missions to be executed.

Multi-objective optimizer 400 receives a fuel cost metric 402 from a fleet fuel consumption module 404. The fuel cost metric is determined using an asset fuel consumption profile 406 for each asset from data received from performance monitoring equipment located on-board each asset in a fuel utilization baselining process 408. Such data may be determined manually, if the asset lacks the performance monitoring equipment. A route fuel requirement profile 410 is also used to determine fuel cost metric 402 using route specific planning data predetermined by the asset owner using business considerations and regulatory constraints. For example, a takeoff portion of a mission may be required by local restrictions to include a steep climbout for noise mitigation in the vicinity of the airport. A steeper climbout translates into a greater fuel consumption requirement during takeoff. Additionally, a short runway also dictates a fuel consumption requirement during takeoff. Route fuel requirement profile 410 also uses real-time weather and atmospheric data to determine conditions that affect the fuel requirement profile for the route to be traversed. Accordingly, fuel cost metric 402 incorporates data relating to the fuel utilization performance of each asset, and the fuel utilization implications of the routes to be traversed and the weather and/or environmental conditions of the route in real-time. Fuel cost metric 416 provides an input to multi-objective optimizer 400 that tends to cause the asset to be matched with missions that can best utilize the assets fuel efficiency capabilities to yield the lowest total fleet fuel consumption.

Multi-objective optimizer 400 also receives a shop load metric 412 from a fleet repair schedule estimation 414. A goal of multi-objective optimizer 400 is to facilitate reducing variation of the workload of repair and maintenance shops that perform maintenance and repair work on the assets of the fleet. Matching assets to missions optimally considers evening the work load of the shops to facilitate reducing servicing costs associated with the fleet of assets. For example, having service triggers for a plurality of assets expiring at substantially the same time would introduce inefficiencies into the servicing of the assets due to labor overtime costs, storage and handling of the assets, and the unavailability of the assets for assignment to missions. A removal from service date is predicted using asset fuel consumption profile 406, trends of deteriorating performance determined by monitoring and diagnostic systems associated with the asset, current remaining life estimations using assessments of the life remaining of asset component parts and the trends of deteriorating performance, and inspections of the asset. A removal from service date is predicted and fleet repair schedule estimate 414 determines how much shop time the maintenance and/or repair required will need for completion. Shop load metric 412 is used to determines dates and shop resources that will be required to perform the required maintenance/repair.

A repair cost metric 416 provides another input to multi-objective optimizer 400 that is indicative of the life remaining in an asset based on asset fuel consumption profile 406, trends of deteriorating performance determined by monitoring and diagnostic systems associated with the asset, current remaining life estimations using assessments of the life remaining of asset component parts and the trends of deteriorating performance, and inspections of the asset. Repair cost metric 416 provides an input to multi-objective optimizer 400 that tends to cause the life of all components of the asset to be used before the asset is removed from service. For example, an asset may have a first component that has a failure rate influenced by operating hours of the asset and a second component that has a failure rate influenced by the number of start and stop cycles the asset experiences. If, during operation, operating hours of the asset were nearing a value wherein the first component would be expected to fail and the number of starts experienced by the asset were relatively few compared to the value wherein the second component would be expected to fail, repair cost metric 416 would tend to influence multi-objective optimizer 400 to match the asset with a mission that required relatively few operating hours with respect to the number of starts required. In the case wherein the asset was an aircraft engine, repair cost metric 416 would tend to influence multi-objective optimizer 400 to match the aircraft to a mission including short haul routes that would tend to even the asset start life with the asset operating hours life such that when removal from service was dictated, both the asset start life and the asset operating hours life would be substantially expended.

It will be appreciated that a technical effect of the configurations of the present invention described herein is the automatic optimization of the management of a fleet of assets.

The above-described embodiments of a fleet management system provide a cost-effective and reliable means for matching assets to missions such that the capabilities of the assets are matched to each mission to facilitate optimizing the performance of the entire fleet of assets. More specifically, the missions are analyzed to determine the environmental and performance demands of the missions and the assets are analyzed to determine the capability of the assets. The assets and missions are then matched to generate asset/mission pairs that reduce fleet operating, maintenance, and service costs. As a result, the methods and systems described herein facilitate operating a fleet of assets in a cost-effective and reliable manner

Exemplary embodiments of fleet asset management systems are described above in detail. The systems are not limited to the specific embodiments described herein, but rather, components of each system may be utilized independently and separately from other components described herein. Each system component can also be used in combination with other system components.

While the invention has been described in terms of various specific embodiments, those skilled in the art will recognize that the invention can be practiced with modification within the spirit and scope of the claims.

What is claimed is:

1. A mission planning system for a fleet of assets comprising:
a centralized database for storing information;
a computer system configured to be coupled to the database, the computer system further comprising:
a mission model configured to analyze a plurality of missions to be executed by the fleet of assets, the missions being defined by at least one task sequence and a set of environmental parameters associated with each task sequence;
an asset model configured to determine the capability of each asset to perform the task sequence associated with at least one mission using the historical data, the threshold data, and the mission analysis; and
a selection model configured to match at least one asset to each mission based on the determined asset capability, such that the capability of all assets is facilitated being optimized.

2. A system in accordance with claim 1 wherein said computer system further comprises a forecast model configured to estimate the result of the mission-asset matching to determine a set of mission-asset matches that facilitates optimizing the capability of all assets.

3. A system in accordance with claim 1 wherein said mission model comprises a route model configured to determine task sequences to be executed.

4. A system in accordance with claim 3 wherein said task sequences include a travel leg length, an asset loading wherein the asset loading includes at least one of passengers, cargo, and fuel, and profiles of an altitude, an ambient temperature, a wind speed, a current speed, an ambient humidity along the travel leg.

5. A system in accordance with claim 3 wherein said profiles include at least one of an average profile value for the travel leg, a transfer function relating travel conditions to profile values, and a transfer function relating travel conditions to profile values that includes an profile value uncertainty distribution.

6. A system in accordance with claim 1 wherein said asset model comprises a fuel consumption model configured to determine a current and projected fuel consumption profile for each said asset.

7. A system in accordance with claim 1 wherein said selection model comprises a route selector configured to match at least one asset to a mission such that at least one of the total fleet fuel consumption is facilitated being minimized, an average time to failure is facilitated being maximized, and an average time to required maintenance is facilitated being maximized.

8. A system in accordance with claim 1 wherein said route selector comprises at least one of an exhaustive algorithm, a non-exhaustive search method, and an evolutionary algorithm.

9. A system in accordance with claim 1 wherein said asset model comprises a life estimation model configured to estimate the life of the asset.

10. A system in accordance with claim 1 wherein said a selection model is further configured to match at least one asset to each mission based on the determined asset capability, such that the capability of all assets is facilitated being optimized and wherein the capability of all assets is facilitated being optimized when the fuel cost of the fleet of assets is minimized, the maintenance and repair shop load is substantially levelized over time, and asset repair costs are minimized.

11. A method of managing life cycle costs associated with maintaining and operating a fleet of assets, said method comprising:
storing historical data relating to missions executed by each asset in a database, the historical data includes asset performance data and environmental data for each mission;
storing threshold data for each asset in the database, the threshold data relating to endurance limits for each asset;
analyzing a plurality of missions to be executed, the missions defined by at least one task sequence and a set of environmental parameters associated with each task sequence;
determining the capability of each asset to perform the task sequence associated with at least one mission using the historical data, the threshold data, and the mission analysis; and
matching at least one asset to each mission based on the determined asset capability, such that the capability of all assets is facilitated being optimized, the matching is performed using a computer.

12. A method in accordance with claim 11 wherein storing historical data relating to missions executed by each asset comprises storing at least one of a travel leg length, an asset loading wherein the asset loading includes at least one of passengers, cargo, and fuel, profiles of an altitude, an ambient temperature, a wind speed, a current speed, an ambient humidity along the travel leg.

13. A method in accordance with claim 11 wherein storing historical data relating to missions executed by each asset comprises storing information relating to asset fuel efficiency.

14. A method in accordance with claim 13 wherein storing historical data relating to missions executed by each asset comprises storing fuel use data for each asset relative to each task of a task sequence.

15. A method in accordance with claim 14 wherein determining the capability of each asset to perform the task sequence comprises determining a projected fuel consumption profile for each asset.

16. A method in accordance with claim 15 wherein matching at least one asset to each mission comprises matching at least one asset to each mission such that the total fuel consumption of the fleet of assets is facilitated being minimized.

17. A method in accordance with claim 11 wherein storing historical data relating to missions executed by each asset comprises storing data associated with a predetermined asset failure mechanism.

18. A method in accordance with claim 17 wherein storing historical data relating to missions executed by each asset comprises storing asset operating hours and asset start events.

19. A method in accordance with claim 18 wherein determining the capability of each asset to perform the task sequence comprises comparing the historical asset operating hours data and asset start events data to associated asset operating hours threshold data and asset start event data.

20. A method in accordance with claim 19 wherein matching at least one asset to each mission comprises matching an asset with a relatively large differential between historical operating hours and threshold operating hours to a mission that includes a relatively large operating hour requirement.

21. A method in accordance with claim 19 wherein matching at least one asset to each mission comprises matching an asset with a relatively large differential between historical asset start events and threshold asset start events to a mission that includes a relatively large asset start events requirement.

22. A computer program embodied on a computer readable medium for managing life cycle costs associated with maintaining and operating a fleet of assets, said program comprising at least one code segment that:
stores historical data relating to missions executed by each asset in a database wherein the historical data includes asset performance data and environmental data for each mission;
stores threshold data for each asset in the database, the threshold data relating to endurance limits for each asset;
analyzes a plurality of missions to be executed, the missions defined by at least one task sequence and a set of environmental parameters associated with each task sequence;
determines the capability of each asset to perform the task sequence associated with at least one mission using the historical data, the threshold data, and the mission analysis; and
matches at least one asset to each mission based on the determined asset capability, such that the capability of all assets is facilitated being optimized, the matching is performed using a computer.
